(19) United States
(12) Patent Application Publication
(10) Pub. No.: US 2026/0246626 A1
(43) Pub. Date: Aug. 20, 2026

(54) KEY DERIVATION OPERATION

(71) Applicant: STMicroelectronics International N.V., Geneva (CH)

(72) Inventors: Christian CORNESSE, Miramas (FR); Yanis LINGE, Fuveau (FR)

(73) Assignee: STMicroelectronics International N.V., Geneva (CH)

(21) Appl. No.: 19/542,017

(22) Filed: Feb. 17, 2026

(30) Foreign Application Priority Data
Feb. 18, 2025 (FR) FR2501657

(51) Int. Cl. H04L 9/08; H04L 9/06

(52) U.S. Cl. CPC H04L 9/0861; H04L 9/0631

(57) ABSTRACT

The present disclosure relates to a method for implementing a key-derivation operation of an encryption algorithm. The method is adapted to receive a first key and to generate a second key, the first and second keys each comprising a number N of bytes arranged in an array. First bytes of a byte row of a first rank of the second key are calculated using second bytes of a byte row of the first rank of the first key, and a single third byte of a byte row of a second rank, different from the first rank, of the first key.

### PRIORITY CLAIM

This application claims the priority benefit of French Application for Patent No. FR2501657, filed on Feb. 18, 2025, the content of which is hereby incorporated by reference in its entirety to the maximum extent allowable by law.

### TECHNICAL FIELD

The present disclosure generally concerns electronic systems and devices, and the management of data within electronic systems and devices. The present disclosure more particularly concerns the encryption of data within an electronic system or device, and the use of an encryption algorithm. More specifically, it concerns the implementation of a derivation operation of an encryption algorithm.

### BACKGROUND

Data encryption algorithms are widely used to process sensitive or secret data.

Although an encryption algorithm can hide sensitive or secret data, the implementation of the algorithm itself may be insecure. Indeed, various types of attack are known and may be implemented during the application of an encryption algorithm.

It would be desirable to improve, at least partly, certain aspects of implementations of encryption algorithms.

There exists a need for a more secure implementation of encryption algorithms.

There exists a need for a more secure implementation of encryption algorithms of the advanced encryption standard (AES) type.

There exists a need for a more secure implementation of a key derivation operation of an encryption algorithm.

There exists a need for a more secure implementation of a key derivation operation of an encryption algorithm of the advanced encryption standard (AES) type.

There exists a need for key derivation operations that have an implementation robust against attacks such as side-channel attacks and fault injection attacks.

### SUMMARY

An embodiment overcomes all or part of the disadvantages of known encryption algorithms.

An embodiment overcomes all or part of the disadvantages of known implementations of a key derivation operation.

An embodiment overcomes all or part of the disadvantages of known AES-type encryption algorithms.

An embodiment overcomes all or part of the disadvantages of known implementations of key derivation operations of known AES-type encryption algorithms.

An embodiment provides an implementation of a derivation operation robust against attacks such as side-channel attacks and fault injection attacks.

An embodiment provides an implementation of an encryption algorithm robust against attacks such as side-channel attacks and fault injection attacks.

An embodiment provides a method for implementation of a key derivation operation of an encryption algorithm adapted to receiving a first key and to delivering a second key, said first and second keys each comprising a number N of bytes arranged in array form, wherein first bytes of a byte row of a first rank of said second key are calculated by using: second bytes of a byte row of the first rank of said first key; and a single third byte of a row of a second rank, different from the first rank, of said first key.

Another embodiment provides a device for implementing the above method of implementation of a key derivation operation of an encryption algorithm adapted to receiving a first key and to delivering a second key, said first and second keys each comprising a number N of bytes arranged in array form, wherein first bytes of a byte row of a first rank of said second key are calculated by using: second bytes of a byte row of the first rank of said first key; and a single third byte of a row of a second rank, different from the first rank, of said first key.

According to an embodiment, said data encryption algorithm is of the advanced encryption standard type.

According to an embodiment, said third byte is the last byte in the byte row of the first rank incremented by one in said first key.

According to an embodiment, each of said first bytes is obtained by applying a first EXCLUSIVE OR-type logical function to one or more of said second bytes, to a fourth byte depending on said third byte, and to a fifth byte.

According to an embodiment, said fourth byte is obtained by applying a second substitution function.

According to an embodiment, said fifth byte is a constant rank byte.

According to an embodiment, each of said first bytes is obtained by applying said first function to the same number of bytes.

According to an embodiment, each of said first bytes is obtained by applying said first function to, further, an even number of sixth masking bytes.

According to an embodiment, the order of application of said first function is different for each of said first bytes.

According to an embodiment, the order of application of said first function is different at each implementation of said method.

According to an embodiment, said first and second keys are 128-bit, 192-bit, or 256-bit binary words.

Another embodiment provides a method for implementation of a data encryption algorithm using the previously-described method.

Another embodiment provides a data encryption device adapted to implementing the above method.

Another embodiment provides a computer program product comprising program code instructions recorded on a medium usable in a computer, comprising computer-readable programming means for carrying out the previously-described method when said program is running on a computer.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows an embodiment of an electronic device;

FIG. 2 shows, in the form of blocks, the implementation of an encryption algorithm;

FIG. 3 shows, in the form of blocks, the implementation of a key derivation operation;

FIG. 4 shows, in the form of blocks, an implementation mode of a key derivation operation;

FIG. 5 shows, in the form of blocks, another implementation mode of a key derivation operation;

FIG. 6 shows, in the form of blocks, another implementation mode of a key derivation operation; and

FIG. 7 shows, in the form of blocks, another implementation mode of a key derivation operation.

### DETAILED DESCRIPTION

Like features have been designated by like references in the various figures. In particular, the structural and/or functional features that are common among the various embodiments may have the same references and may exhibit identical structural, dimensional and material properties.

For the sake of clarity, only those steps and elements that are useful for understanding the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as the terms “front”, “back”, “top”, “bottom”, “left”, “right”, etc., or relative position qualifiers, such as the terms “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

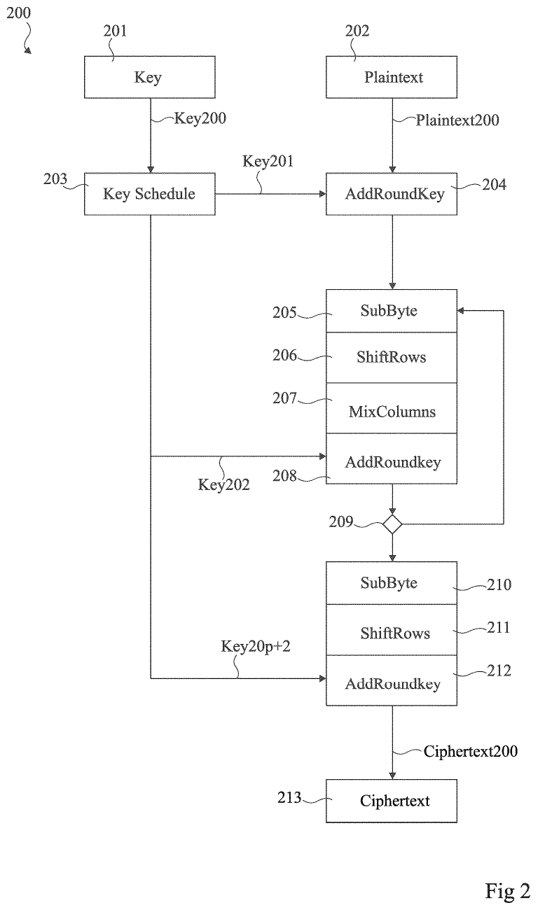

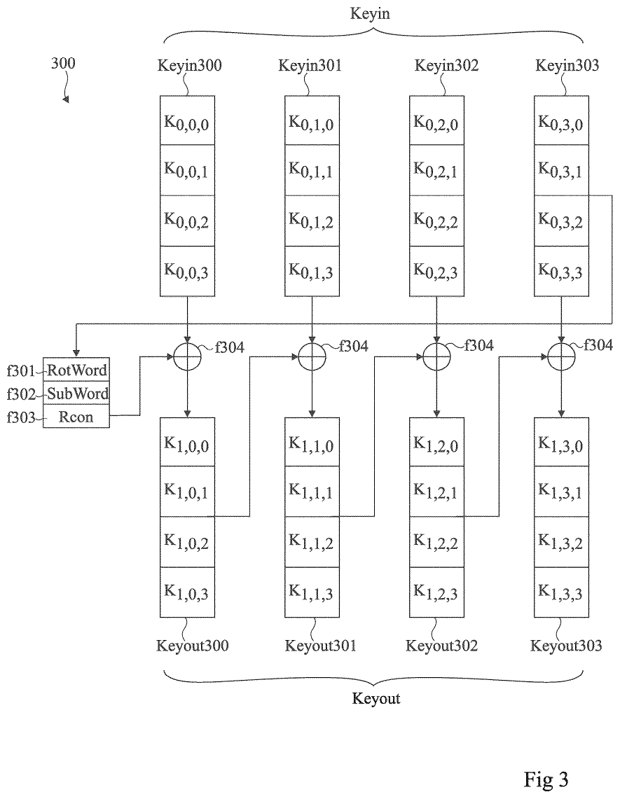

The embodiments described hereafter concern cryptography and the application of encryption algorithms to secret or sensitive data. Here, secret or sensitive data having a content which is not intended to be public, and the access to which is restricted to a controlled number of users. The embodiments described hereafter more particularly relate to the use of an encryption algorithm of the type of the algorithm called advanced encryption standard (AES), which is a round-robin encryption algorithm. The general operation of the AES is described in relation with FIGS. 2 and 3.

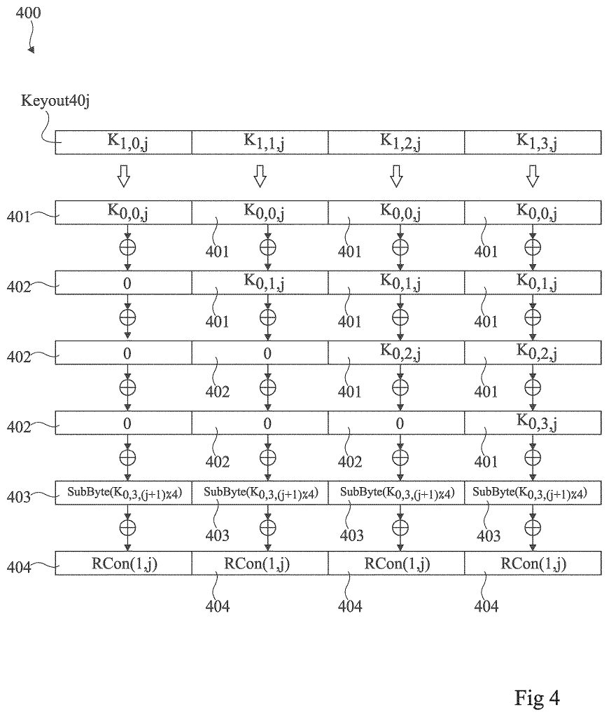

There currently exist different types of malicious attacks that attempt to gain access to secret or sensitive data during the implementation of an encryption algorithm. Among these attacks, side-channel attacks and fault-injection attacks are particularly used. To thwart these attacks, it is necessary to make the implementation of the encryption algorithm increasingly difficult to analyze, and this is what the embodiments described hereafter intend to do. Indeed, these embodiments concern, more particularly, a more secure implementation of a key derivation operation used during the implementation of an encryption algorithm such as the AES. This implementation is based on a row-based management of the data bytes forming the keys, and not on a column-based management like conventional implementations. Various variants of this implementation are described in relation with FIGS. 4 to 7.

Further, the embodiments described hereafter are particularly adapted to being used in any type of industrial market where data encryption is required. More particularly, such a data-encryption method may be intended for:
the automotive industry, for example in the field of automotive electrification or in the field of advanced driver assistance systems (ADAS);
the industrial sector, for example in the field of green energy, in the field of infrastructure electrification, in the Internet of Things (IoT), and in smart-home technologies, where electricity and energy consumption and data exchange are key elements;
the personal electronics industry, for example in the field of mobile telephony and IoT devices, as well as in the field of high-speed interfaces; and
the industry of communications equipment, computers, and peripherals, for example in the field of infrastructure and data centers, and in the field of low-earth-orbit (LEO) satellites.

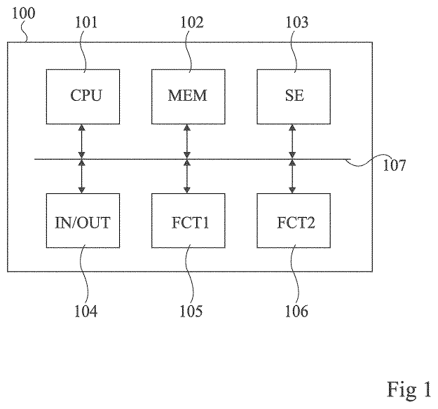

FIG. 1 is a block diagram schematically showing an architecture of an example of an electronic device 100 adapted to implementing a data-encryption algorithm.

Electronic device 100 comprises a processor 101 (CPU) adapted to implementing various processing operations on data stored in memories and/or provided by other circuits of device 100. According to an embodiment, processor 101 may be adapted to implementing a data-encryption algorithm.

Electronic device 100 further comprises different types of memories 102 (MEM), including, for example, non-volatile memory, volatile memory, and/or read-only memory. Each memory 102 is adapted to storing different types of data. According to an example, some of memories 102 may be adapted to storing encrypted data and/or encryption keys.

Electronic device 100 further comprises, for example, a secure element 103 (SE) adapted to processing sensitive and/or secret data. Secure element 103 may comprise its own processor(s), its own memory or memories, etc. According to an embodiment, secure element 103 is adapted to implementing a data-encryption method using an encryption algorithm.

Electronic device 100 may further comprise interface circuits 104 (IN/OUT) adapted to sending and/or receiving data from outside device 100. Interface circuits 104 may further be adapted to implementing a data display, for example through a display screen.

Electronic device 100 further comprises various circuits 105 (FCT1) and 106 (FCT2) adapted to carrying out different functions. As an example, circuits 105 and 106 may comprise measurement circuits, data-conversion circuits, etc. According to an embodiment, circuits 105 and 106 may comprise a circuit adapted to implementing a data-encryption algorithm.

Electronic device 100 further comprises one or more data buses 107 adapted to transferring data between its various components.

According to a specific example, electronic device 100 is adapted to implementing computer programs, and in particular a computer program enabling implementation of a wireless communication method, for example a computer program enabling implementation of a data-encryption algorithm.

More specifically, electronic device 100 is adapted to implementing at least one computer-program product comprising program-code instructions recorded on a medium usable in a computer, comprising computer-readable programming means for implementing the data-encryption algorithm when said program is running on a computer.

FIG. 2 is a block diagram illustrating the implementation of a data-encryption algorithm 200.

According to an example, data-encryption algorithm 200 is an algorithm of the type called the advanced encryption standard (AES), or AES. According to a preferred example, algorithm 200 is the AES. Algorithm 200 is a round-robin algorithm, that is, an algorithm which comprises a number of steps which are successively executed a plurality of times.

Algorithm 200 starts with two parallel steps 201 (Key) and 202 (Plaintext) of generation and/or delivery of data required for the application of algorithm 200.

More specifically, at step 201, an encryption key Key200 is generated or retrieved. According to an example, key Key200 is formed of a number N of bytes, N being an integer, arranged in array form, that is, in rows and columns. According to a preferred example, N is equal to 128, but may also be equal to 192 or 256.

At step 202, the data item Plaintext200 to be encrypted is supplied to algorithm 200. According to an example, data item Plaintext200 is made to comply with a format adapted to algorithm 200. To achieve this, padding operations may be implemented.

At step 203 (Keyschedule), consecutive to step 201, key Key200 is derived. In other words, step 203 is a key-derivation step which takes as an input a first key, here key Key200, and outputs a second key which has the same format as the input key. According to an example, step 203 may be implemented iteratively and provide a plurality of derived keys. According to an example, the key-derivation function implemented at step 203 may be implemented again at each round of algorithm 200 to provide a new key from the key obtained at the previous round. At the first round of algorithm 200, step 203 provides a derived key Key201. More particularly, operation 203 is described in more detail in relation with FIG. 3.

At a step 204 (AddRoundKey), consecutive to steps 202 and 203, the data item to be encrypted, Plaintext200, is encrypted for a first time by using the derived key Key201.

At a step 205 (SubByte), consecutive to step 204, a substitution function is applied to the data item obtained at the previous step. Such a substitution function is well known to those skilled in the art of cryptography.

At a step 206 (ShiftRows), consecutive to step 205, a row-shift function is applied to the data item obtained at the previous step. Such a row-shift function is well known to those skilled in the art of cryptography.

At a step 207 (MixColumns), consecutive to step 206, a column-mixing function is applied to the data item obtained at the previous step. Such a column-mixing function is well known to those skilled in the art of cryptography.

At a step 208 (AddRoundKey), consecutive to step 207, the data item obtained at the previous step is encrypted by using a new derived key Key202 provided by a new implementation of step 203.

Steps 205 to 208 form a round of algorithm 200. According to an example, algorithm 200 is implemented p times, p being an integer.

At step 209, consecutive to step 208, it is checked whether the number of rounds is smaller than p. If it is, then the next step is step 205; otherwise the next step is step 210.

At a step 210 (SubByte), consecutive to step 209, the substitution function of step 205 is applied to the data item obtained at the previous step.

At a step 211 (ShiftRows), consecutive to step 210, the row-shift function of step 206 is applied to the data item obtained at the previous step.

At a step 212 (AddRoundKey), consecutive to step 211, the data item obtained at the previous step is encrypted by using a last derived key Key20p+2 provided by a new implementation of step 203.

Steps 210 to 212 form the final round of algorithm 200.

At a final step 213 (Ciphertext), algorithm 200 may provide the encrypted data Ciphertext200.

FIG. 3 is a block diagram illustrating a conventional implementation of a key-derivation operation 300 of a data-encryption algorithm.

According to an example, operation 300 is of the type implemented at step 203 of algorithm 200 described in relation with FIG. 2.

In the example shown in FIG. 3, operation 300 is adapted to receiving, as an input, an input encryption key Keyin over 128 bits, that is, 16 bytes, and to providing, as an output, an output encryption key Keyout over 128 bits, that is, 16 bytes. It is within the abilities of those skilled in the art to adapt the description of operation 300 to the processing of a 192-bit or 256-bit key.

To be processed by operation 300, input key Keyin is shown in array form. In other words, input key Keyin may be given by the following mathematical formula:

$$Keyin = ( \begin{matrix}{K}_{0 , 0 , 0} & {K}_{0 , 1 , 0} & {K}_{0 , 2 , 0} & {K}_{0 , 3 , 0} \\ {K}_{0 , 0 , 1} & {K}_{0 , 1 , 1} & {K}_{0 , 2 , 1} & {K}_{0 , 3 , 1} \\ {K}_{0 , 0 , 2} & {K}_{0 , 1 , 2} & {K}_{0 , 2 , 3} & {K}_{0 , 3 , 2} \\ {K}_{0 , 0 , 3} & {K}_{0 , 1 , 3} & {K}_{0 , 2 , 4} & {K}_{0 , 3 , 3}\end{matrix} )$$

Output key Keyout is also shown in array form. In other words, output key Keyout can be given by the following mathematical formula:

$$Keyout = ( \begin{matrix}{K}_{1 , 0 , 0} & {K}_{1 , 1 , 0} & {K}_{1 , 2 , 0} & {K}_{1 , 3 , 0} \\ {K}_{1 , 0 , 1} & {K}_{1 , 1 , 1} & {K}_{1 , 2 , 1} & {K}_{1 , 3 , 1} \\ {K}_{1 , 0 , 2} & {K}_{1 , 1 , 2} & {K}_{1 , 2 , 3} & {K}_{1 , 3 , 2} \\ {K}_{1 , 0 , 3} & {K}_{1 , 1 , 3} & {K}_{1 , 2 , 4} & {K}_{1 , 3 , 3}\end{matrix} )$$

To implement the key-derivation operation, input key Keyin is processed in byte columns. In other words, logical and mathematical functions are applied to the bytes of the columns of key Keyin. Four functions are used:
a word-rotation function f301 (RotWord), which enables shifting the bytes by one or more positions in the column, preferably by one position upwards;
a word-substitution function f302 (SubWord), of the type implemented during step 205 described in relation with FIG. 2;
a function f303 (Rcon) for generating a byte considered as a constant byte, also refered to as as a constant-rank byte; and
a function f304 representing a logical EXCLUSIVE OR function.

Due to the application of the operation, the bytes in the first column Keyout300 of output key Keyout can also be given by the following mathematical formulas:

$$Keyout 300 = \{ \begin{matrix}{K}_{1 , 0 , 0} = {K}_{0 , 0 , 0} xor SubByte ( {K}_{0 , 3 , 1} ) xor Rcon ( 1 ) \\ {K}_{1 , 0 , 1} = {K}_{0 , 0 , 1} xor SubByte ( {K}_{0 , 3 , 2} ) \\ {K}_{1 , 0 , 2} = {K}_{0 , 0 , 2} xor SubByte ( {K}_{0 , 3 , 3} ) \\ {K}_{1 , 0 , 3} = {K}_{0 , 0 , 3} xor SubByte ( {K}_{0 , 3 , 0} )\end{matrix}$$

where:
   xor represents the logical EXCLUSIVE OR function;
   SubByte represents function f302; and
   Rcon(1) represents function f303.

Those skilled in the art will be capable of determining, based on these formulas, the formulas enabling definition of the bytes of the other columns Keyout301, Keyout302, and Keyout303.

A disadvantage of column-based processing of operation 300 is that for each calculation of a coefficient of output key Keyout, two coefficients of input key Keyin are used and can be made accessible through the use of a malicious attack.

FIG. 4 is a block diagram illustrating an implementation mode of a key derivation operation 400 of a data encryption algorithm.

According to an example, operation 400 is of the type implemented at step 203 of algorithm 200 described in relation with FIG. 2 and of the type of operation 300 described in relation with FIG. 3.

In the example of FIG. 4, and like operation 300 of FIG. 3, operation 400 is adapted to receiving, as an input, the input encryption key Keyin over 128 bits, or 16 bytes, of FIG. 3 and to providing, as an output, the output encryption key Keyout over 128 bits, or 16 bytes, of FIG. 3. It is within the ability of those skilled in the art to adapt the description of operation 400 to the processing of a 192-bit or 256-bit key.

Conversely to operation 300 of FIG. 3, in operation 400, input key Keyin is processed by row and not by column. In other words, the operation is implemented by considering the bytes of input key Keyin row by row, rather than column by column.

By the application of operation 400, the bytes of a row Keyout40j of rank j, j being in the range from 0 to 3, 0 and 3 included, of output key Keyout are given by the following mathematical formulas:

$$Keyout 40 j = \{ \begin{matrix}{K}_{1 , 0 , j} = {K}_{0 , 0 , j} xor SubByte ( {K}_{0 , 3 , ( j + 1 ) \%4} ) xor Rcon ( 1 ) \\ {K}_{1 , 1 , j} = {K}_{0 , 1 , j} xor {K}_{1 , 0 , j} \\ {K}_{1 , 2 , j} = {K}_{0 , 2 , j} xor {K}_{1 , 1 , j} \\ {K}_{1 , 3 , j} = {K}_{0 , 3 , j} xor {K}_{1 , 2 , j}\end{matrix}$$

It is thus interesting to note that, with a row-based processing, and for the calculation of the bytes of a row of the output key, derivation operation 400 only manipulates the bytes of one row of input key Keyin and a single byte of another row of input key Keyin. In a column-based processing, the calculation of the bytes of a column uses all the bytes of input key Keyin. This is a first advantage of a row-based processing. Indeed, it enables the use of fewer bytes of the input key and thus provides fewer opportunities for leaking the entire input key.

Further, in operation 400, the calculations of the bytes of the same row can all be executed in parallel. This case is shown in FIG. 4. The implementation is divided, for each byte of a row of key Keyout, into i+2 applications of the EXCLUSIVE OR function, i being an integer representing the number of rows of input and output keys Keyin and Keyout. In FIG. 4, this implementation is divided into six applications of the EXCLUSIVE OR function for each byte K_{1,0,j} to K_{1,3,j}., ensuring consistent computational effort across all bytes. This uniformity improves implementation security by avoiding detectable variations. Indeed, it could be detectable to apply the EXCLUSIVE OR function only three times for one byte K_{1,0,j} whereas another byte K_{1,3,j} requires six applications of this function.

Thus, more particularly, the implementation of operation 400 illustrated in FIG. 4 comprises the following successive steps:
one or more steps 401 of application of the EXCLUSIVE OR function to a byte of input key Keyin;
one or more padding steps 402, corresponding to one or more steps of application of the EXCLUSIVE OR function to a null byte, if required;
a step 403 of application of the EXCLUSIVE OR function to a byte corresponding to the application of a substitution function (such as function f302 of FIG. 3) to a byte of input key Keyin; and
a step 404 of application of the EXCLUSIVE OR function to a byte corresponding to a constant-rank byte obtained by the application of a generation function (such as function f303 of FIG. 3).

The number of steps 401 and 402 is calculated so that, for a given row, all bytes are obtained using the same number of steps.

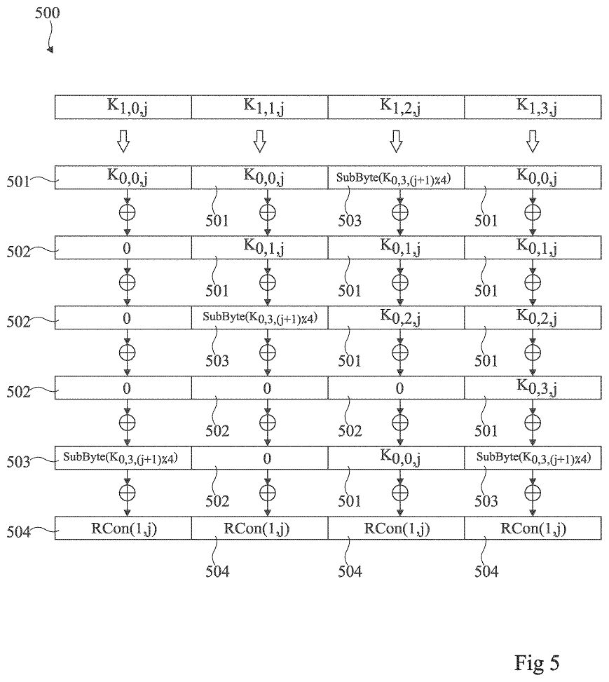

FIG. 5 is a block diagram illustrating an implementation mode of a key derivation operation 500 of a data encryption algorithm.

Operation 500 is similar to operation 400 described in relation with FIG. 4. The elements common to operations 400 and 500 are not described again herein in detail. However, the differences between operations 400 and 500 are highlighted.

Like operation 400, operation 500 is adapted to receiving, as an input, the input encryption key Keyin over 128 bits, that is, 16 bytes, of FIG. 3 and to providing, as an output, the output encryption key Keyout over 128 bits, that is, 16 bytes, of FIG. 3.

Like operation 400, operation 500 consists of a row-processing of the key derivation operation implemented at step 203 of algorithm 200 described in relation with FIG. 2. Operation 500 is divided into a plurality of applications of the EXCLUSIVE OR function. Thus, more particularly, the implementation of operation 500 shown in FIG. 5 comprises the following successive steps:
one or more steps 501 of application of the EXCLUSIVE OR function to a byte of input key Keyin, of the type of step 401 of operation 400;
one or more padding steps 502, which correspond to one or more steps of application of the EXCLUSIVE OR function to a null byte, if required, of the type of step 402 of operation 400;
a step 503 of application of the EXCLUSIVE OR function to a byte corresponding to the application of a substitution function (such as function f302 of FIG. 3) to a byte of input key Keyin, of the type of step 403 of operation 400; and
a step 504 of application of the EXCLUSIVE OR function to a byte corresponding to a constant-rank byte obtained by the application of a generation function (such as function f303 of FIG. 3), of the type of step 404 of operation 400.

Unlike operation 400, in operation 500, the order in which steps 501, 502 (if relevant), 503, and 504 are implemented may be different for each byte of the same row.

According to an example, the order in which steps 501, 502 (if applicable), 503, and 504 are carried out may be different each time operation 500 is carried out.

An advantage of this implementation mode is that it further improves the robustness and unpredictability of operation 500.

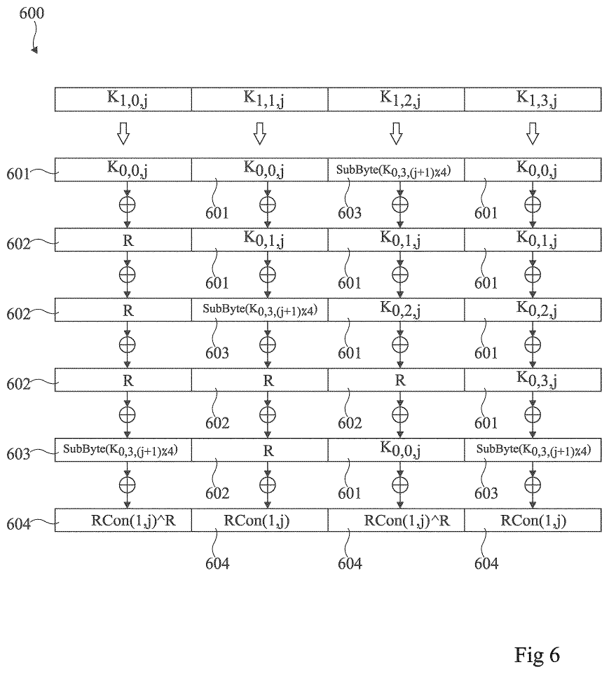

FIG. 6 is a block diagram illustrating an implementation mode of a key derivation operation 600 of a data encryption algorithm.

Operation 600 is similar to operation 400 described in relation with FIG. 4 and to operation 500 described in relation with FIG. 5. The elements common to operations 400, 500, and 600 are not described again herein in detail. However, the differences between operations 400, 500, and 600 are highlighted.

Like operations 400 and 500, operation 600 is adapted to receiving, as an input, the input encryption key Keyin over 128 bits, that is, 16 bytes, of FIG. 3 and to providing, as an output, the output encryption key Keyout over 128 bits, that is, 16 bytes, of FIG. 3.

Like operations 400 and 500, operation 600 consists of a row processing of the key derivation operation implemented at step 203 of algorithm 200 described in relation with FIG. 2. Operation 600 is divided into a plurality of applications of the EXCLUSIVE OR function. Thus, more particularly, the implementation of operation 600 shown in FIG. 6 comprises the following successive steps:
one or more steps 601 of application of the EXCLUSIVE OR function to a byte of input key Keyin, of the type of step 401 of operation 400;
one or more steps 602 similar to step 402 of operation 400;
a step 603 of application of the EXCLUSIVE OR function to a byte corresponding to the application of a substitution function (such as function f302 of FIG. 3) to a byte of input key Keyin, of the type of step 403 of operation 400; and
a step 603 of application of the EXCLUSIVE OR function to a byte corresponding to the application of a substitution function (such as function f302 of FIG. 3) to a byte of input key Keyin, of the type of step 403 of operation 400; and
a step 604 of application of the EXCLUSIVE OR function to a byte corresponding to a constant rank byte obtained by the application of a generation function (such as function f303 of FIG. 3), of the type of step 404 of operation 400.

Like operation 500, in operation 600, the order of implementation of steps 601, 602 (if relevant), 603, and 604 may be different for each byte of a same row.

Unlike operations 400 and 500, steps 602 are not steps of application of the EXCLUSIVE OR function to a null byte, but to a byte R representing a masking data item, for example a randomly generated masking data item.

According to an example, when the number of steps 602 is even, all steps 602 represent the entire application of the EXCLUSIVE OR function to byte R. However, when the number of steps 602 is odd, byte R must be used in an odd number of the other steps of operation 600 as a masking byte.

An advantage of this implementation mode is to improve the robustness of operation 600.

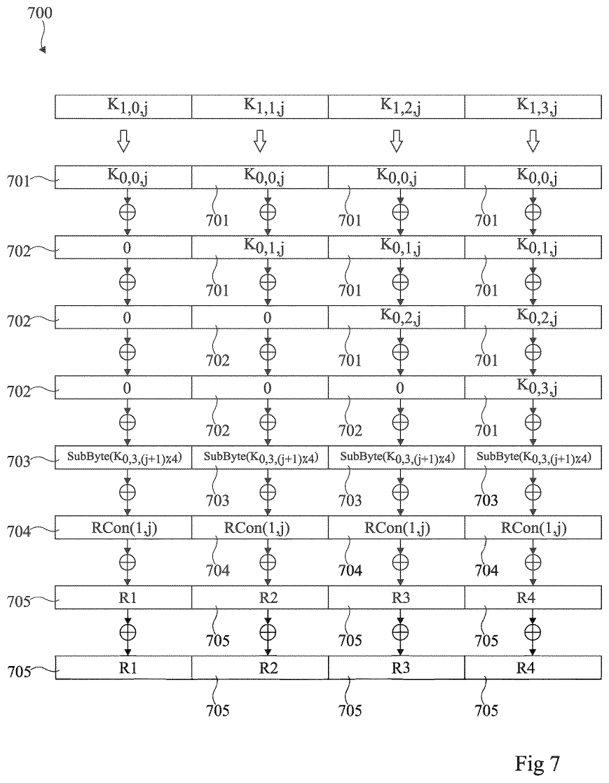

FIG. 7 is a block diagram illustrating an implementation mode of a key derivation operation 700 of a data encryption algorithm.

Operation 700 is similar to the operation 400 described in relation with FIG. 4. The elements common to operations 400 and 700 are not described again herein in detail. However, the differences between operations 400 and 700 are highlighted.

Like operation 400, operation 700 is adapted to receiving, as an input, the input encryption key Keyin over 128 bits, that is, 16 bytes, of FIG. 3 and to providing, as an output, the output encryption key Keyout over 128 bits, that is, 16 bytes, of FIG. 3.

Like operation 400, operation 700 consists of a row-processing of the key derivation operation implemented at step 203 of algorithm 200 described in relation with FIG. 2. Operation 700 is divided into a plurality of applications of the EXCLUSIVE OR function. Thus, more particularly, the implementation of the operation 700 illustrated in FIG. 7 comprises the following successive steps:
one or more steps 701 of application of the EXCLUSIVE OR function to a byte of input key Keyin, of the type of step 401 of operation 400 one or more padding steps 702 which correspond to one or more steps of application of the EXCLUSIVE OR function to a null byte, if required, of the type of step 402 of operation 400;
a step 703 of application of the EXCLUSIVE OR function to a byte corresponding to the application of a substitution function (such as function f302 of FIG. 3) to a byte of input key Keyin, of the type of step 403 of operation 400; anda step 704 of application of the EXCLUSIVE OR function to a byte corresponding to a constant rank byte obtained by the application of a generation function (such as the function f303 of FIG. 3), of the type of the step 404 of operation 400.

Unlike operation 400, operation 700 further comprises steps 705 of application of the EXCLUSIVE OR function to one or more masking bytes R1, R2. According to an example, byte(s) R1, R2 are adapted to representing randomly-obtained data. According to an example, the operation comprises an even number of steps 705 applied to each masking byte.

An advantage of this implementation mode is to improve the robustness of operation 700.

Various embodiments and variants have been described. Those skilled in the art will understand that certain features of these various embodiments and variants may be combined, and other variants will occur to those skilled in the art. In particular, the implementation modes of FIGS. 4 to 7 can all be combined.

Finally, the practical implementation of the described embodiments and variants is within the abilities of those skilled in the art based on the functional indications given hereabove.

1. A method implementing a key derivation operation for an encryption algorithm, the method comprising:
receiving a first key and generating a second key, said first and second keys each comprising a number N of bytes arranged in an array;
calculating first bytes of a byte row of a first rank of said second key by using:
second bytes of a byte row of the first rank of said first key; and
a single third byte of a row of a second rank, different from the first rank, of said first key.

2. The method according to claim 1, wherein said data encryption algorithm is of an advanced encryption standard (AES) type.

3. The method according to claim 1, wherein said third byte is the last byte in the byte row of the first rank incremented by one in said first key.

4. The method according to claim 1, wherein each of said first bytes is obtained by applying a first EXCLUSIVE-OR (XOR) logic function to: one or more of said second bytes, a fourth byte that depends on said third byte, and to a fifth byte.

5. The method according to claim 4, wherein said fourth byte is obtained by applying a second substitution function.

6. The method according to claim 4, wherein said fifth byte is a constant rank byte.

7. The method according to claim 4, wherein each of said first bytes is obtained by applying said first function to a same number of bytes.

8. The method according to claim 4, wherein each of said first bytes is obtained by also applying said first function to an even number of sixth masking bytes.

9. The method according to claim 4, wherein an order of application of said first function is different for each of said first bytes.

10. The method according to claim 4, wherein the order of application of the first function varies between different executions of the method.

11. The method according to claim 1, wherein said first and second keys are 128-bit, 192-bit or 256-bit binary words.

12. A device, comprising:
a processor configured to implement a key-derivation operation of an encryption algorithm, the processor being configured to receive a first key and to provide a second key, the first and second keys each comprising a number N of bytes arranged in an array,
wherein first bytes of a byte row of a first rank of the second key are calculated using:
second bytes of a byte row of the first rank of the first key; and
a single third byte of a byte row of a second rank, different from the first rank, of the first key.

13. The device of claim 12, wherein the encryption algorithm is of an Advanced Encryption Standard (AES) type.

14. The device of claim 12, wherein the third byte is a last byte in the byte row of the first rank incremented by one in the first key.

15. The device of claim 12, wherein each of the first bytes is obtained by applying a first EXCLUSIVE-OR (XOR) logic function to: one or more of the second bytes, a fourth byte that depends on the third byte, and a fifth byte.

16. The device of claim 15, wherein the fourth byte is obtained by applying a substitution function.

17. The device of claim 15, wherein the fifth byte is a constant-rank byte.

18. The device of claim 15, wherein each of the first bytes is obtained by applying the first function to a same number of bytes.

19. The device of claim 15, wherein each of the first bytes is obtained by further applying the first function to an even number of sixth masking bytes.

20. The device of claim 15, wherein an order of application of the first function is different for each of the first bytes.

21. The device of claim 12, wherein the first and second keys are 128-bit, 192-bit, or 256-bit binary words.
